(19) United States
(12) Patent Application Publication
(10) Pub. No.: US 2011/0162920 A1
(43) Pub. Date: Jul. 7, 2011

(54) VEHICULAR ANTI-THEFT SYSTEM

(76) Inventors: EITAN GAL, Ashdod (IL); Elior Zohar, Ashdod (IL); Assaf Ben Lulu, Ashdod (IL); Meir Gitelis, Tel Aviv (IL)

(21) Appl. No.: 12/983,311

(22) Filed: Jan. 2, 2011

Related U.S. Application Data
(60) Provisional application No. 61/291,922, filed on Jan. 4, 2010.

(51) Int. Cl. B60T 7/12; B60T 13/16

(52) U.S. Cl. 188/110

(57) ABSTRACT

In one aspect, the present invention is directed to a vehicular anti-theft system, comprising: sealed housing (31), interposed between the power brake boost (12) and the brake pump (14) of a wheel of a vehicle, the housing generating a closed space with the hydraulic space of the brake; an indication module (110), for indicating whether the vehicle is locked; a pushing mechanism (112), for pushing the transmission (24) of the hydraulic pump (14) of the wheel; and a controller (32), for activating the pushing mechanism (112) to push the transmission (24) upon indicating by the indication module (110) that the vehicle is locked; thereby braking the wheel upon locking the vehicle.

### CROSS-REFERENCE TO RELATED APPLICATIONS

This application claims the benefit of priority from U.S. Provisional Patent Application Ser. No. 61/291,922, titled “Vehicle Wheel Locking System”, and filed Jan. 4, 2010, which is incorporated herein by reference.

### FIELD OF THE INVENTION

The present invention relates to the field of vehicular anti-theft systems.

### BACKGROUND OF THE INVENTION

Currently, a variety of vehicular anti-theft locking systems are available on the market. Some of them neutralize engine or starter motor operation through an immobilizer system, which is electronic security device attached to the vehicle that stops the engine from working in order to prevent the car from being stolen. Burglars previously overcame such vehicular anti-theft systems by entering the vehicle's cab, regardless of alarms, releasing the vehicle's handbrake, and towing it away with a towing vehicle.

It is an object of the present invention to provide a solution to the above-mentioned and other problems of the prior art.

Other objects and advantages of the invention will become apparent as the description proceeds.

### SUMMARY OF THE INVENTION

In one aspect, the present invention is directed to a vehicular anti-theft system, comprising:
sealed housing (31), interposed between the power brake boost (12) and the hydraulic brake pump (14) of a wheel of a vehicle, the housing generating a closed space with the hydraulic space of the brake system;
an indication module (110), for indicating whether the vehicle is locked;
a pushing mechanism (112), for pushing the push rod (25) of the hydraulic brake pump (14) of the wheel regardless to activation of the brake pedal (10) thereof; and
a controller (32), for activating the pushing mechanism (112) to push the transmission (24) upon indicating by the indication module (110) that the vehicle is locked;

thereby braking the wheel upon locking the vehicle.

According to one embodiment of the invention (illustrated in FIG. 3), the pushing mechanism (112) comprises:
a lever (26) connected to the transmission (24); and
an electric piston (28), for applying force on the lever (26) upon being activated by the controller (32).

According to another embodiment of the invention (illustrated in FIG. 7), the pushing mechanism (112) comprises:
a hydraulic pump (60), for applying hydraulic pressure on the space (52) of the hydraulic brake pump (14), from both sides of the piston (54) of the hydraulic brake pump (14).

According to yet another embodiment of the invention (illustrated in FIG. 8), the pushing mechanism (112) comprises:
an electric motor;
a ledge (74) connected to the transmission; and
a screw rod (80), connected to the ledge (74), the screw rod operated by the electric motor.

The system may further comprise a sensor (30), for sensing the pressure in the closed space, thereby allowing the controller (32) to increase pressure in the closed space upon pressure reduction.

The system may further comprise a sensor (30), the sensor (30) comprising:
an arm (29) connected to the electric piston (28) and to the lever (26);
a switch (44); and
a spring (46), for retracting the lever to push the switch (44) upon reducing the pressure in the closed space under a certain level.

According to one embodiment of the invention, the indication module comprises:
wireless connection with the remote control of the burglar alarm system of the vehicle; and
circuitry for analyzing the signal.

According to another embodiment of the invention, the indication module comprises:
wired connection with the module of an alarm system installed in the vehicle; and
circuitry for analyzing the state of the alarm.

The sealed housing may be connected to the brake boost by shear off head bolts (38).

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

### BRIEF DESCRIPTION OF THE DRAWINGS

Embodiments and features of the present invention are described herein in conjunction with the following drawings:

FIG. 1 schematically illustrates a part of a vehicular brake system in its idle state, according to the prior art.

FIG. 2 schematically illustrates the system of FIG. 1 in its active state.

FIG. 3 schematically illustrates a vehicular anti-theft system, according to one embodiment of the invention.

FIG. 4 is a zoomed sectional view schematically illustrating the vehicular anti-theft system of FIG. 3.

FIG. 5 is a magnified view of pressure sensor 30 illustrated in FIG. 3.

FIG. 6 schematically illustrates a process of mounting a vehicular anti-theft system, according to another embodiment of the invention.

FIG. 7 is a sectional zoomed view illustrating the structure of vehicular anti-theft system 20a illustrated in FIG. 6.

FIG. 8 is a two-dimensional diagram illustrating a vehicular anti-theft system 20b, according to yet another embodiment of the invention.

FIG. 9 is a block diagram schematically illustrating the major modules and operation of an anti-theft system of a vehicle, according to one embodiment of the invention.

It should be understood that the drawings are not necessarily drawn to scale.

### DETAILED DESCRIPTION OF THE INVENTION

The present invention will be understood from the following detailed description of preferred embodiments, which are meant to be descriptive and not limiting. For the sake of brevity, some well-known features, methods, systems, procedures, components, circuits, and so on, are not described in detail.

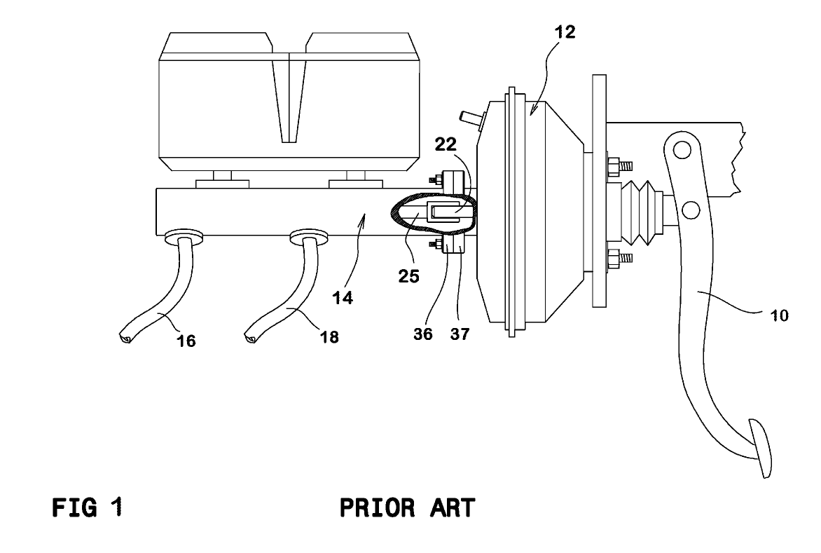

FIG. 1 schematically illustrates a part of a vehicular brake system in its idle state, according to the prior art.

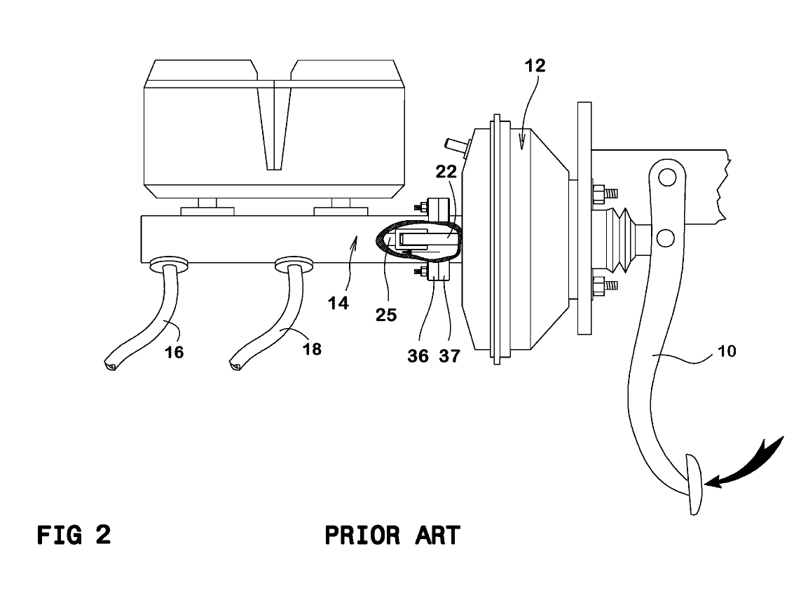

FIG. 2 schematically illustrates the system of FIG. 1 in its active state.

In these figures a part of brake pump 14 is presented as broken, in order to expose inner parts thereof.

Upon pressing brake-pedal 10 by a user, power brake boost 12 moves push rod 22, which pushes rod 25, which is connected to a piston (not illustrated) that pushes oil out of outlet pipes 16 and 18, which are connected to the friction members of the brake (not illustrated).

Flange 36 of hydraulic brake pump 14 is connected to flange 37 of power brake boost 12 by bolts.

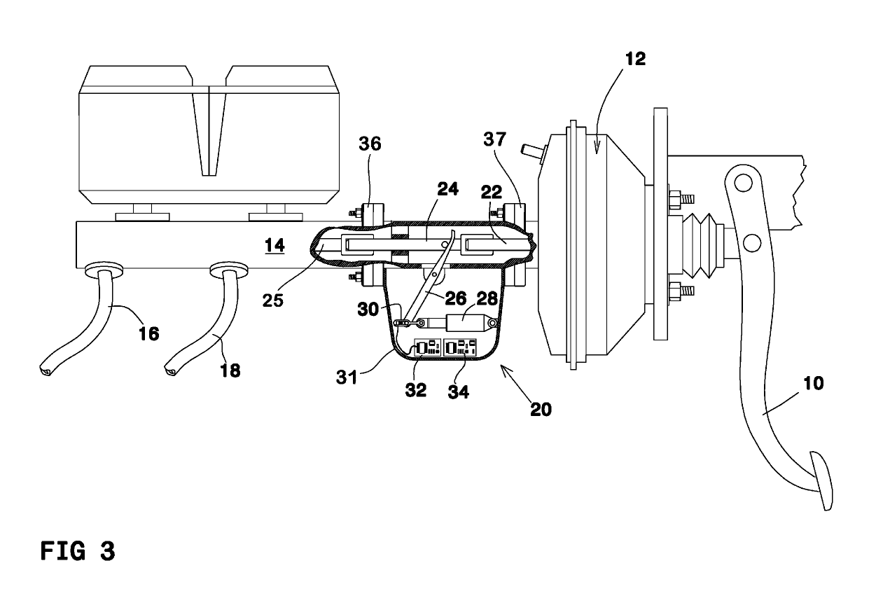

FIG. 3 schematically illustrates a vehicular anti-theft system, according to one embodiment of the invention.

In this figure some parts are presented as broken, in order to expose inner parts thereof.

The vehicular anti-theft system, which is marked herein by reference numeral 20, is interposed between the power brake boost 12 and brake pump, by flanges (seen in the figure, but unmarked by reference numeral, as the figure has limited space) connected to flange 36 of hydraulic brake pump 14 and flange 37 of power brake boost 12.

The vehicular anti-theft system is disposed into a sealed housing 31, which generates a closed hydraulic space with the hydraulic space of the brake system of the wheel thereof.

The vehicular anti-theft system operates in response to activating/deactivating the vehicle's burglar alarm system. This can be carried out, for example, by a wireless connection module 34, which illustrated in this figure as printed circuit.

Upon activating the vehicle's alarm system by a remote control thereof, wireless connection module 34 receives an instruction to activate the brake system of the wheel. Thus, the wireless connection module 34 may be adapted to process wireless signals transmitted by the remote control of the burglar alarm of the vehicle.

Additionally or alternatively, wireless connection module 34 may be connected by wires or wireless connection to the module of the burglar alarm system (not illustrated) which is installed in the vehicle, thereby “knowing” when the vehicular burglar alarm has been activated.

A transmission 24 is interposed between push rod 25 of brake pump 14 and push rod 22 of brake boost 12. Transmission 24 transfers the pushing power of push rod 22 to push rod 25.

The wireless connection module 34 passes on that instruction to electronic controller 32. Controller 32 activates electric piston 28, which pulls lever 26, which pushes transmission 24 to disengage from rod 22, thereby disengaging brake pump 14 from brake boost 12. As a result of this operation, brake pedal 10 is neutralized, while the brake is active. Thus, on activating the burglar alarm system of the vehicle, the brake is applied, which means that the vehicle resists being moved.

Sensor 30 senses the hydraulic pressure in system 20. If the hydraulic pressure falls below a certain threshold, the force applied by lever 26 is increased, thereby keeping the brake active.

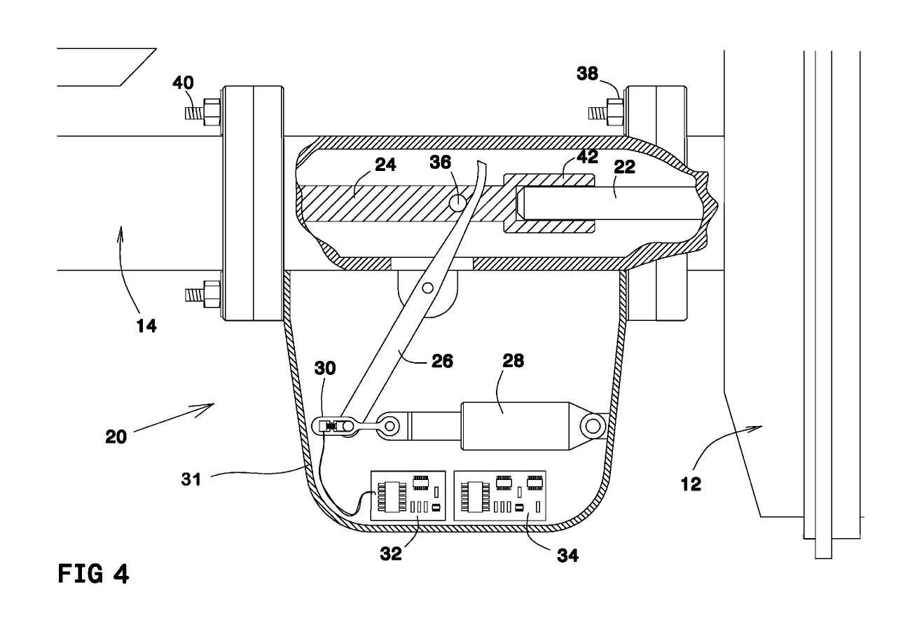

FIG. 4 is a zoomed sectional view schematically illustrating the vehicular anti-theft system of FIG. 3.

Bolts 38 connecting system 20 to power brake boost 12 may be bolts with a shear off head, which makes it difficult to dismantle the system.

Bolts 40 that connect system 20 to hydraulic brake pump 14 may be “regular” bolts. When the brake pedal is pressed, push rod 22 on the power brake boost is pushed and in turn, it pushes transmission 24, which operates hydraulic brake pump 14.

Upon activating system 20, electric piston 28 retracts, and pulls lever 26, which pushes transmission 24, that activates the hydraulic brake pump 14. In addition, push rod 22 is disconnected from transmission 24 and only pump 14's operation is available, i.e., the brake pedal is neutralized. Reference numeral 42 denotes a female connector, which mates with push rod 22.

Sensor 30 detects the braking force (actually the hydraulic pressure, which reflects the braking force) and as required, increases braking force by retracting the electric piston 28 again.

The system is operated using an electronic controller 32 and a wireless connection module 34, illustrated as an electronic card.

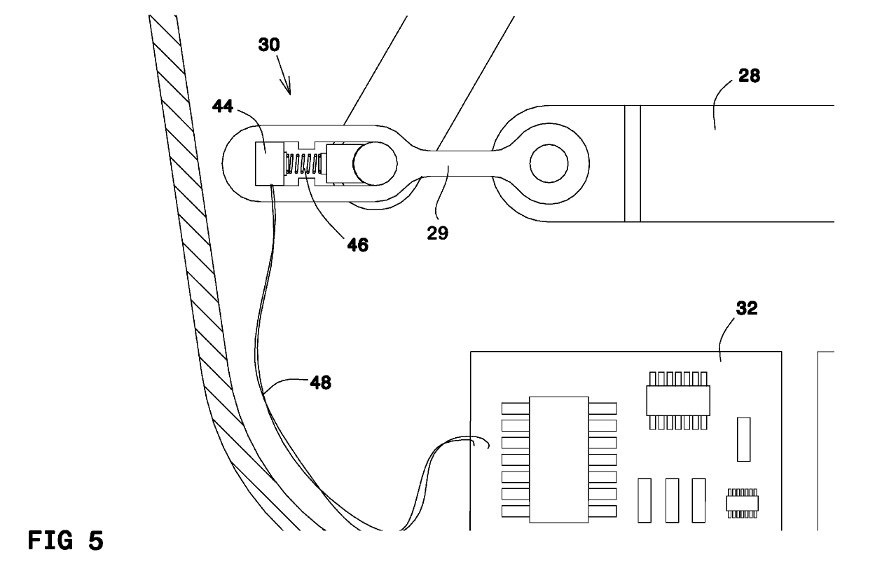

FIG. 5 is a magnified view of pressure sensor 30 illustrated in FIG. 3.

Upon receiving an instruction to apply brake power (i.e., upon activating the burglar alarm of the vehicle), electric piston 28 retracts and pulls arm 29, which is connected to the piston 28. As a result, spring 46 is compressed and push switch 44 is pressed. Controller 32, to which switch 44 is connected through conductive wires 48, receives the state of switch 44.

If an attempt is made to remove vehicular anti-theft system 20, the hydraulic pressure in the brake line is decreased, causing arm 29 to move back due to the drop in pressure, spring 46 expands, and the pressure on switch 44 ceases. As controller 32 is aware of the situation of switch 44, the controller further retracts that piston until it receives information that switch 44 has been pressed again.

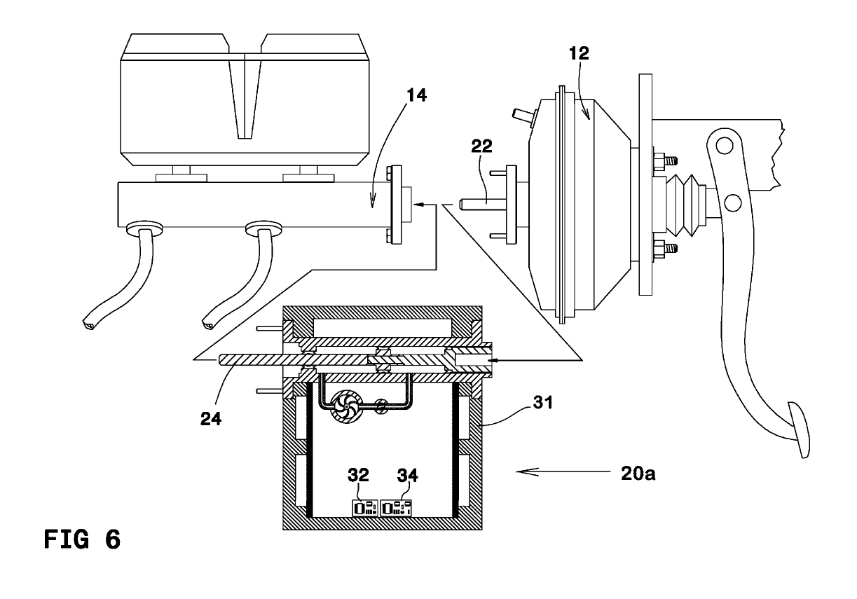

FIG. 6 schematically illustrates a process of mounting a vehicular anti-theft system, according to another embodiment of the invention.

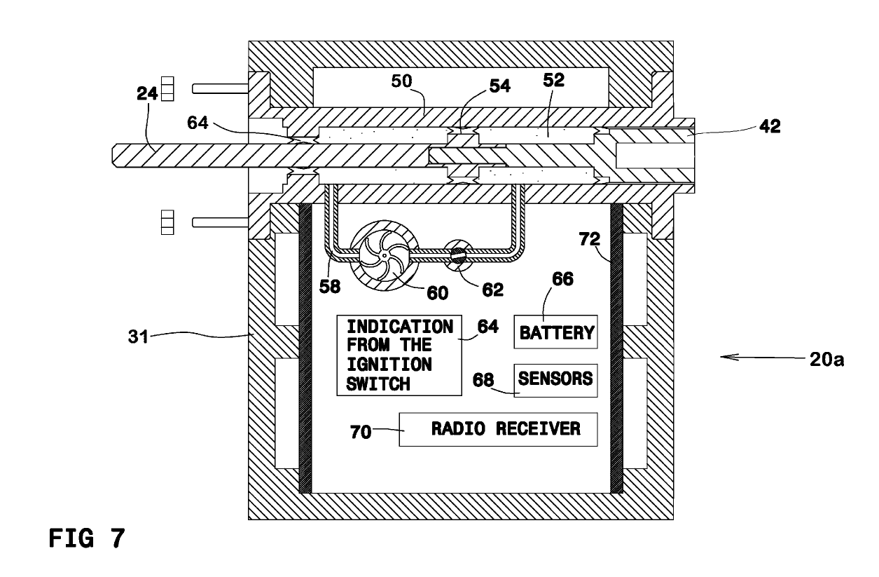

This vehicular anti-theft system is marked by reference numeral 20a, and is further detailed in FIG. 7 and the description thereof. While hydraulic brake pump 14 and power brake boost 12 are illustrated pictorially, vehicular anti-theft system 20a is illustrated in sectional view.

Vehicular anti-theft system 20a is installed between the power brake boost 12 and the brake pump 14 of a wheel of a vehicle. Push rod 22 of power brake boost 12 goes into the vehicular anti-theft system 20a, and the system's exit transmission 24 goes into brake pump 14.

The vehicular anti-theft system is connected to the vehicle's burglar alarm system through a wireless connection module 34 (illustrated as electronic card).

Upon activating the vehicle's burglar alarm system by pressing an appropriate switch on the alarm's remote control, wireless connection module 34 receives an instruction to lock the vehicle's wheels, and passes on that instruction to the electronic controller 32.

FIG. 7 is a sectional zoomed view illustrating the structure of vehicular anti-theft system 20a illustrated in FIG. 6.

The locking mechanism of this system is hydraulic. In this embodiment, transmission 24 is disposed into a cylinder 50. Space 52 of cylinder 50 is confined by piston 54 and connector 42, which is designed as a seal. A pipe 58 is connected to space 52 from both sides of piston 54. A pump 60 is connected to pipe 58. Thus, transmission 24 is moved by pump 60. Upon closing pipe 58 by electric valve 62, transmission 24 is fixed to its current position.

As illustrated, connector 42 and transmission 24 are different entities, thereby pump 60 can move transmission 24 in only in one way.

When the vehicle's driver is not pressing down on the brake pedal, the spring expands and the cylinders return to their initial positions.

When the vehicle's burglar alarm system is activated, hydraulic pump 60 starts working and sucks hydraulic fluid of space 52 from the space in the left side of the piston 54 and transfers that fluid from the left side of piston 54 to the right side of piston 54 through the bypass pipe 58 and through the electric valve 62.

At the end of the stage in which hydraulic fluid is pumped into the space in the right side of the piston 54, the bypass pipe is sealed closed by the electric valve 62.

Closing the electric valve 62 prevents any return of hydraulic fluid through the bypass pipe into the left side of the piston and that causes the locking of transmission 24 and the brake system.

Vehicular anti-theft system 20a is installed within a “safe” location, such as a structure which protects all the system's parts against intrusion.

The inner part of the “safe” location has double wall reinforcement to augment its ability to resist intrusion.

The following components are located inside the “safe” location:

Rechargeable battery, which enables system operation even when the vehicle's battery is disconnected; sensors designed to detect the pressure of the hydraulic fluid in the system and increase that pressure when necessary (if the pressure drops in the vehicle's brake system); a radio receiver which can be adjusted to the frequency and code used by the vehicle's remote control; a system that checks whether the vehicle's key has been inserted into the steering wheel lock and turned (open or closed).

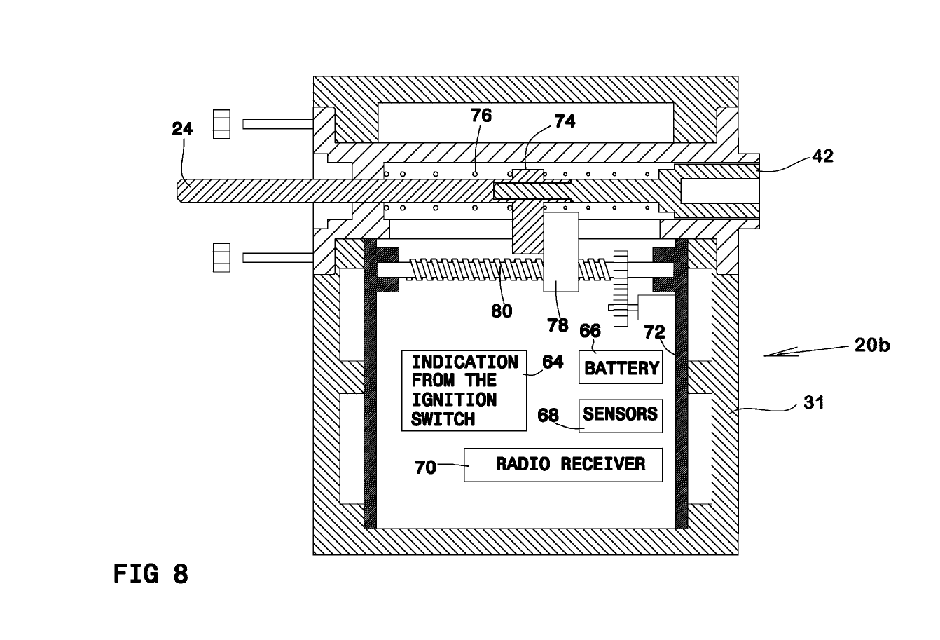

FIG. 8 is a two-dimensional diagram illustrating a vehicular anti-theft system 20b, according to yet another embodiment of the invention.

The locking mechanism of this system is mechanical.

This configuration is different from the configuration illustrated in FIGS. 3 to 5, in that in this configuration, movement is controlled by a screw 80 rather than by an electric piston.

During braking, the power brake boost pushes rod linked to female connector 42 pushes the push rod for the vehicular anti-theft system by a ledge 74 connected to transmission 24, and the spring 76 is compressed.

When the brake pedal is released, the push rod and the spring 76 return to their initial positions.

When the vehicle's alarm system is activated, radio receiver 70 checks whether the vehicle key operating the ignition system is in the open or closed position and if the key is in the open position, the vehicular anti-theft system does not function.

If the vehicle key is in its closed position, the electric motor drives the screw rod 80 and consequently, the ledge 78 moves to the left and pushes push ledge 74 and locks the vehicular anti-theft system. As the locking system operates, sensors 68 measure hydraulic pressure in the braking system.

Backup battery 66 ensures system operation even when the vehicle battery has been disconnected.

The protection box 31, the housing, is constructed in a “secured” manner, such as with a double protection wall 72.

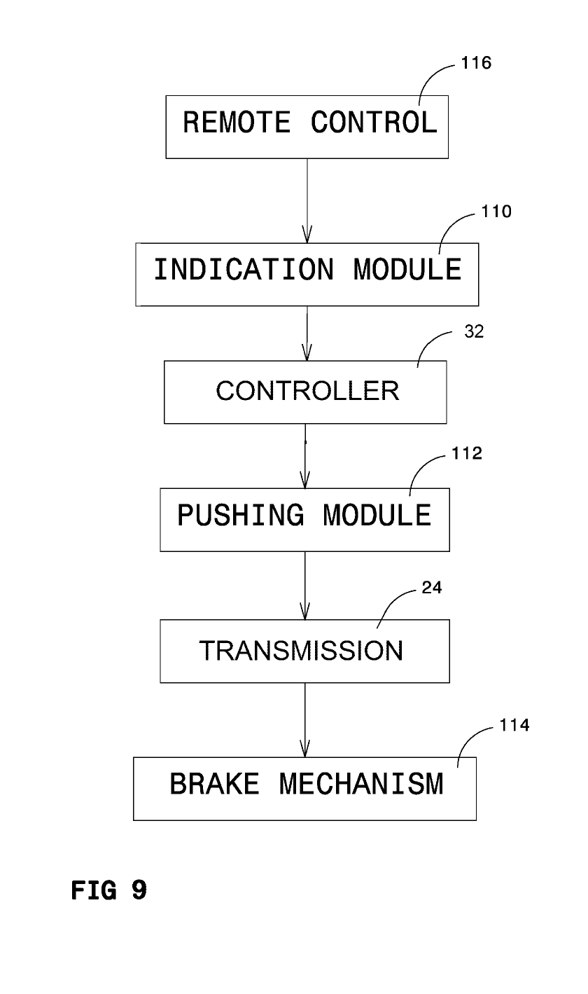

FIG. 9 is a block diagram schematically illustrating the major modules and operation of an anti-theft system of a vehicle, according to one embodiment of the invention.

Upon activating a remote control 116 of the vehicle, an indication module 110 indicates to a controller 32 this situation. The controller instructs a pushing module 112 to push transmission 24 of a brake system of a wheel. As a result, a force is applied on the brake mechanism 114 of the wheel, which prevents moving the vehicle.

A direct connection of the remote control with the anti-theft system prevents moving the vehicle, even if the burglar has succeeded to turn on its motor.
Numeral 10 denotes a brake pedal of a vehicle;

numeral 12 denotes a brake boost;
numeral 14 denotes a hydraulic brake pump;
numeral 16 denotes an outlet pipe from brake pump 14;
numeral 18 denotes an outlet pipe from brake pump 14;
numeral 20 denotes a vehicular anti-theft system (illustrated for example in FIG. 3) according to one embodiment of the invention; in this embodiment the power applied on transmission 24 to disengage from brake boost 12 is generated by an electric piston 28;
numeral 20a denotes a vehicular anti-theft system (illustrated for example in FIG. 7) according to another embodiment of the invention; in this embodiment the power applied on transmission 24 to disengage from brake boost 12 is generated by a hydraulic pump 60;
numeral 20b denotes a vehicular anti-theft system (illustrated for example in FIG. 8) according to yet another embodiment of the invention; in this embodiment the power applied on transmission 24 to disengage from brake boost 12 is generated by a screw rod 80;
numeral 22 denotes a push rod of piston of hydraulic pump 14; by applying power on this rod, pump 14 applied brake power on the wheel thereof;
numeral 24 denotes a one-way transmission, by which push rod 22 applies power on push rod 25;
numeral 25 denotes a push rod connected to the piston of brake pump 14;
numeral 26 denotes a lever;
numeral 28 denotes an electric piston;
numeral 30 denotes a sensor for sensing whether the fluid pressure in the hydraulic space of casing 31 is lower than a predefined threshold thereof;
numeral 31 denotes a housing of an anti-theft system (20, 20a, 20b);
numeral 32 denotes a controller;
numeral 34 denotes a wireless connection module;
numeral 36 denotes a flange of brake pump 14;
numeral 38 denotes a shear off head bolt;
numeral 40 denotes a “regular” bolt;
numeral 42 denotes a female connector, which mates with push rod 22;
numeral 44 denotes a switch;
numeral 46 denotes a spring;
numeral 48 denotes conductive wires;
numeral 50 denotes a cylinder;
numeral 52 denotes a closed space of cylinder 50;
numeral 54 denotes a piston inside cylinder 50;
numeral 58 denotes a pipe;
numeral 60 denotes a hydraulic pump;
numeral 62 denotes an electric valve;
numeral 64 denotes a seal;
numeral 66 denotes a backup battery;
numeral 68 denotes a sensor for measuring the hydraulic pressure in the braking system;
numeral 70 denotes a radio receiver;
numeral 72 denotes a double protection wall;
numeral 74 denotes a ledge connected to transmission 24;
numeral 76 denotes a spring;
numeral 78 denotes a ledge connected to screw rod 80;
numeral 80 denotes a screw rod;
numeral 110 denotes an indication module (mechanism);
numeral 112 denotes a pushing module (mechanism);
numeral 114 denotes (a brake mechanism; and
numeral 116 denotes a remote control.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

What is claimed is:

1. A vehicular anti-theft system, comprising:
sealed housing, interposed between the power brake boost and the hydraulic brake pump of a wheel of a vehicle, said housing generating a closed space with the hydraulic space of said brake system;
an indication module, for indicating whether said vehicle is locked;
a pushing mechanism, for pushing the push rod (25) of the hydraulic pump of said wheel regardless to activation of the brake pedal thereof; and
a controller, for activating said pushing mechanism to push said transmission upon indicating by said indication module that said vehicle is locked;
thereby braking said wheel upon locking said vehicle.

2. A system according to claim 1, wherein said pushing mechanism comprises:
a lever connected to said transmission; and
an electric piston, for applying force on said lever upon being activated by said controller.

3. A system according to claim 1, wherein said pushing mechanism comprises:
a hydraulic pump, for applying hydraulic pressure on the space of said hydraulic brake pump, from both sides of the piston of said pump.

4. A system according to claim 1, wherein said pushing mechanism comprises:
an electric motor;
a ledge connected to said transmission; and
a screw rod, connected to said ledge, said screw rod operated by said electric motor.

5. A system according to claim 1, further comprising a sensor, for sensing the pressure in said closed space, thereby allowing said controller to increase the pressure in said closed space upon reducing said pressure.

6. A system according to claim 2, further comprising a sensor, said sensor comprising:
an arm connected to said electric piston and to said lever;
a switch; and
a spring, for retracting said lever to push said switch upon reducing the pressure in said closed space under a certain level.

7. A system according to claim 1, wherein said indication module comprises:
wireless connection with the remote control of the burglar alarm system of said vehicle; and
circuitry for analyzing said signal.

8. A system according to claim 1, wherein said indication module comprises:
wired connection with the module of an alarm system installed in said vehicle; and
circuitry for analyzing the state of said alarm.

9. A system according to claim 1, wherein said sealed housing is connected to said brake boost by shear off head bolts(s).
